(19) United States
(12) Patent Application Publication
(10) Pub. No.: US 2006/0117168 A1
(43) Pub. Date: Jun. 1, 2006

(54) Computer system with restart control circuit

(75) Inventors: Xian-Ming Wang, Shenzhen (CN); Guang-Dong Yuan, Shenzhen (CN); Chien-Hung Lo, Tu-cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/288,688

(22) Filed: Nov. 28, 2005

(30) Foreign Application Priority Data
Nov. 30, 2004 (CN) 200410077236.1

(51) Int. Cl. G06F 15/177

(52) U.S. Cl. 713/1

(57) ABSTRACT

A computer system includes a power supply, a mainboard, and a restart control circuit. The power supply includes a system power source output and a stand-by power source output. The restart control circuit has a first input connected to the system power source output, a second input connected to the stand-by power source output, and an output connected to the mainboard. During an interval of time after the computer system is turned on, the system power source output provides working voltage for the restart control circuit, and the output provides trigger signals at a high level for the mainboard. During an interval of time after the computer system is turned off, the stand-by power source output provides stand-by voltage to the restart control circuit, and the output provides trigger signals at a low level for the mainboard to trigger the computer system to restart.

### BACKGROUND OF THE INVENTION

1. Field of the Invention

The present invention relates to a computer system, and particularly to a computer system with a restart control circuit.

2. General Background

Typically a new mainboard is required to be tested after manufacture. During the course of the test, the mainboard is placed in a computer enclosure to form a computer system and the system is turned on and off repeatedly. Such an action is often done 1000 times or more. Conveniently, after being turned on, the computer system can automatically be turned off by the use of software. However, after being turned off, a power button of the computer enclosure must be pressed by a user to turn the computer system on again.

FIG. 3 discloses a typical process for turning a computer system on manually. A power source control unit 30′ on a bezel of the computer system sends a high-level trigger signal (PS_SWITCH signal) to a receiving terminal of a mainboard 20′. The mainboard 20′ responds to the PS_SWITCH signal to start a power supply 10′. The PS_SWITCH signal is a negative pulse. A pulse length of the PS_SWITCH is several seconds. Then the PS_SWITCH is changed to a low-level signal. Thus, the computer system is turned on.

In testing, repeated turning on of computer systems by users wastes manpower, and influences the efficiency of the testing.

What is needed is to provide a computer system which can automatically restart.

### SUMMARY

A computer system includes a power supply, a mainboard, and a restart control circuit. The power supply includes a system power source output and a stand-by power source output. The restart control circuit has a first input electrically connected to the system power source output of the power supply, a second input electrically connected to the stand-by power source output of the power supply, and an output electrically connected to the mainboard and providing trigger signals to the mainboard. During an interval of time after the computer system is turned on, the system power source output of the power supply provides working voltage to the restart control circuit, and the output of the restart control circuit provides trigger signals at a high level for the mainboard. During an interval of time after the computer system is turned off, the stand-by power source output of the power supply provides stand-by voltage to the restart control circuit, and the output of the restart control circuit provides trigger signals at a low level for the mainboard to trigger the computer system to restart.

Other advantages and novel features of the invention will become more apparent from the following detailed description when taken in conjunction with the accompanying drawings, in which:

### BRIEF DESCRIPTION OF THE DRAWINGS

FIG. 1 is a block diagram of a computer system with a restart control circuit in accordance with a preferred embodiment of the present invention;

FIG. 2 is a circuit diagram of the restart control circuit of FIG. 1; and

FIG. 3 is a block diagram of a conventional computer system.

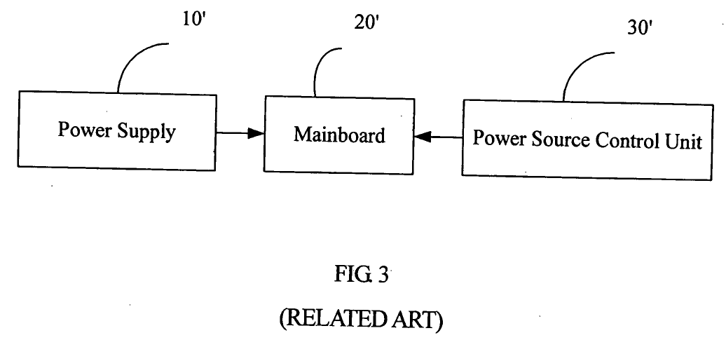

### DETAILED DESCRIPTION OF THE EMBODIMENT

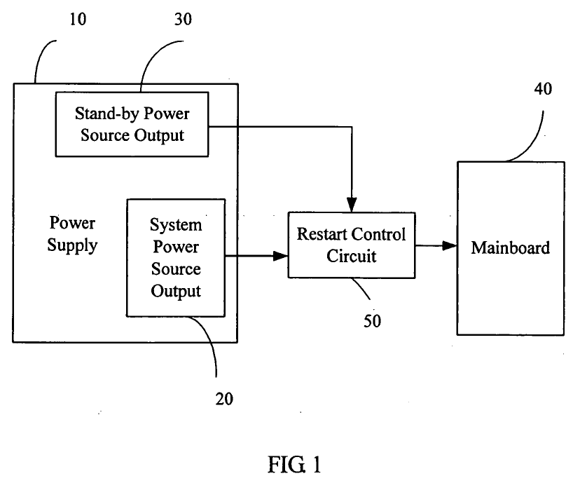

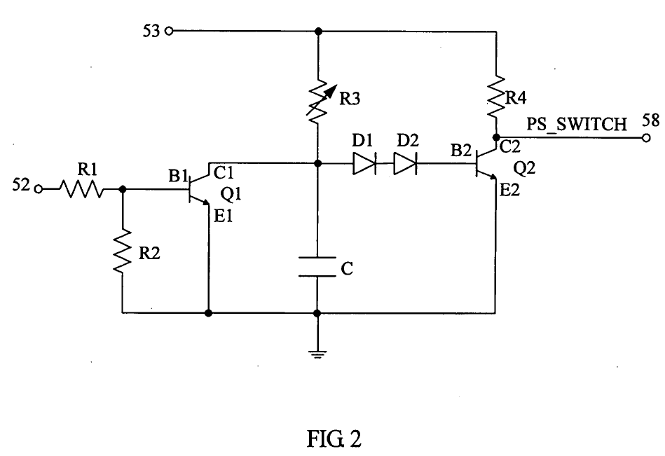

Referring to FIGS. 1 and 2, a computer system in accordance with a preferred embodiment of the present invention is shown. The computer system includes a power supply 10, a mainboard 40, and a restart control circuit 50.

The power supply 10 includes a system power source output 20 and a stand-by power source output 30. The power supply 10 is an ATX power supply typically used in contemporary computer systems. A characteristic of the ATX power supply is the retention of a faint current after the computer system is turned off generating a stand-by voltage. The stand-by voltage generated is +5V_{SB} which is output from the stand-by power source output 30. A system voltage of the power supply 10 is +5V, which is output from the system power source output 20 when the computer system is turned on.

The restart control circuit 50 has a first input 52 connected to the system power source output 20, a second input 53 connected to the stand-by power source output 30, and an output 58.

The first input 52 is electrically connected to the system power source output 20 of the power supply 10. The second input 53 is electrically connected to the stand-by power source output 30 of the power supply 10. The output 58 is electrically connected to the mainboard 40.

The restart control circuit 50 includes a first transistor Q1 used as a first switch device, a second transistor Q2 used as a second switch device, an RC (Resistance-Capacitance) circuit used as a time-delay means and constituted by a capacitor C and an adjustable resistor R3, a first diode D1, a second diode D2, and a plurality of resistors. A first resistor R1 is connected to the first input 52 of the restart control circuit 50 and a base B1 of the first transistor Q1. A second resistor R2 is connected to the base B1 and an emitter E1 of the first transistor Q1. A collector C1 of the first transistor Q1 is connected to an anode of the first diode D1. A cathode of the first diode D1 is connected to an anode of the second diode D2. A cathode of the second diode D2 is connected to a base of the second transistor Q2. An emitter E2 of the second transistor Q2 is connected to the emitter E1 of the first transistor Q1, and then is grounded. A fourth resistor R4 is connected to a collector C2 of the second transistor Q2 and the second input 53 of the restart control circuit 50. The collector C2 of the second transistor Q2 is connected to the output 58 of the restart control circuit 50. The adjustable resistor R3 is connected to the second input 53 and the collector C1 of the first transistor Q1. The capacitor C is connected to the collector C1 and the emitter E1 of the first transistor Q1.

During operation, the restart control circuit 50 cooperates with known means to automatically power up and power down the computer system punctuated by time intervals. The system power source output 20 outputs a +5V system voltage when the computer system is turned on. The base B1 of the first transistor Q1 is at a high level. The first transistor Q1 is turned on. An anode of the capacitor C is at a low level. The first and second diodes D1, D2 are turned off. A PS_SWITCH signal output from the restart control circuit 50 is at a high level. The +5V system voltage supplies a working voltage to the mainboard 40. The computer system is on.

Then by use of know means the computer is turned off. At the instant of power off the computer system a time interval ensues during which the system voltage of +5V disappears and the base B1 of the first transistor Q1 becomes equal to ground. The first transistor Q1 is turned off. The +5V_{SB} stand-by voltage output from the stand-by power source output 30 slowly charges the capacitor C through the adjustable resistor R3. A voltage of the anode of the capacitor C slowly builds and a current of the base B2 of the second transistor Q2 slowly increases. A voltage of the PS_SWITCH signal output from the collector C2 of the second transistor Q2 slowly decreases.

As the voltage of the anode of the capacitor C reaches about +1.5V, the voltage of the PS_SWITCH signal decreases low enough to trigger the computer system to restart and +5V is supplied by the system power source output 20 and the computer system is on. Another time interval (or time delay) ensues during which the first transistor Q1 is turned on and the capacitor C rapidly discharges through the first transistor Q1. The second transistor Q2 is turned off. The voltage of the PS_SWITCH signal is at a high level to supply the working voltage to the mainboard 40. And after a predetermined time interval (or time delay) the computer is turned off again by the known means. Thus, the computer system is in a cyclic mode of “turn on - - - time lag - - - turn off - - - time lag - - - turn on”.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A computer system comprising:
a system power source;
a stand-by power source;
a mainboard having an input receiving trigger signals turning on the computer system; and
a restart control circuit having a first input being provided system voltages from the system power source, a second input being provided stand-by voltages from the stand-by power source, and an output providing working voltages to the mainboard and outputting the trigger signals.

2. The computer system as claimed in claim 1, further comprising a power supply having a system power source output electrically connected to the first input of the restart control circuit to provide the system voltages, and a stand-by power source output electrically connected to the mainboard to provide the stand-by voltages.

3. The computer system as claimed in claim 2, wherein the restart control circuit comprises a first transistor, a second transistor, and a charge and discharge circuit electrically connected to the first transistor, the charge and discharge circuit electrically connected to the stand-by power source output, the second transistor has a collector forming the output of the restart control circuit.

4. The computer system as claimed in claim 3, wherein the charge and discharge circuit comprises a capacitor and an adjustable resistor, the first transistor comprises a collector and an emitter, an anode of the capacitor is electrically connected to the collector of the first transistor, a cathode of the capacitor and the emitter of the first transistor are grounded, the adjustable resistor is electrically connected to the collector of the first transistor and the stand-by power source output of the power supply.

5. The computer system as claimed in claim 4, wherein the first transistor further comprises a base, a first resistor is electrically connected to the base of the first transistor and the system power source output of the power supply.

6. The computer system as claimed in claim 5, wherein a second resistor is electrically connected to the base and the emitter of the first transistor.

7. The computer system as claimed in claim 5, wherein the second transistor further comprises a base and an emitter, a first diode and a second diode series-wound to the first diode are electrically connected to the collector of the first transistor, and the base of the second transistor, the emitter of the second transistor is grounded.

8. A restart control circuit for restarting a computer system having a power supply and a mainboard, the restart control circuit comprising:
an input electrically connected to the power supply; and
an output electrically connected to the mainboard and outputting trigger signals to the mainboard.

9. The restart control circuit as claimed in claim 8, further comprising a first transistor, a second transistor, and a charge and discharge circuit electrically connected to the first transistor, the charge and discharge circuit electrically connected to the power supply, the second transistor has a collector forming the output of the restart control circuit.

10. The restart control circuit as claimed in claim 9, wherein the charge and discharge circuit comprises a capacitor and an adjustable resistor, the first transistor comprises a collector and an emitter, an anode of the capacitor is electrically connected to the collector of the first transistor, a cathode of the capacitor and the emitter of the first transistor are grounded, the adjustable resistor is electrically connected to the collector of the first transistor and the power supply.

11. The restart control circuit as claimed in claim 10, wherein the first transistor further comprises a base, a first resistor is electrically connected to the base of the first transistor and the power supply.

12. The restart control circuit as claimed in claim 11, wherein a second resistor is electrically connected to the base and the emitter of the first transistor.

13. The restart control circuit as claimed in claim 11, wherein the second transistor further comprises a base and an emitter, a first diode and a second diode series-wound to the first diode are electrically connected to the collector of the first transistor and the base of the second transistor, the emitter of the second transistor is grounded.

14. A system to control powering statuses of a circuit component, comprising:
a first power source;
a second power source different from said first power source;
a first switch device electrically connected to said first power source and capable of switching in response to said first power source;
a time-delay means electrically connected between said first switch device and said second power source in order for accepting control of said first switch device and generating predetermined time delay with help of said second power source; and
a second switch device electrically connected between said time-delay means and a circuit component, said second switch device capable of switching to control powering statuses of said circuit component according to said predetermined time delay of said time-delay means.

15. The system as claimed in claim 14, wherein said first and second switch device are transistors respectively.

16. The system as claimed in claim 14, wherein said time-delay means is a Resistance-Capacitance (RC) circuit comprising a capacitor and an adjustable resistor.

17. The system as claimed in claim 14, wherein at least one diode is electrically connected between said time-delay means and said second switch device so as to contribute to effective operation of said second switch device.
